(19) United States
(12) Patent Application Publication
(10) Pub. No.: US 2016/0062841 A1
(43) Pub. Date: Mar. 3, 2016

(54) DATABASE AND DATA ACCESSING METHOD THEREOF

(71) Applicant: Lite-On Technology Corporation, Taipei City (TW)

(72) Inventors: Lieh-Kuang Hu, Taipei City (TW); Ming-Huang Wu, Taipei City (TW)

(21) Appl. No.: 14/525,232

(22) Filed: Oct. 28, 2014

(30) Foreign Application Priority Data
Sep. 1, 2014 (CN) 201410440585.9

(51) Int. Cl. G06F 11/14

(52) U.S. Cl. CPC G06F 11/1448; G06F 11/1412; G06F 2201/80

(57) ABSTRACT

A database and a data accessing method thereof are provided. The database includes a memory, a CPU, a data storage element and a data cache element. The memory is configured to store a kernel program. The CPU is coupled to the memory and configured to execute the kernel program. The data storage element and the data cache element are coupled to the CPU. When receiving a data read command or a data write command from an application, the kernel program determines whether the data storage element is set for accelerated data accessing. If yes, the kernel program guides the data read command to read a copy file from the data cache element or writes a file of the data write command into the data storage element and the data cache element. The copy file is corresponding to a target file in the data storage element.

### CROSS-REFERENCE TO RELATED APPLICATION

This application claims the priority benefit of China application serial no. 201410440585.9, filed on Sep. 3, 2014. The entirety of the above-mentioned patent application is hereby incorporated by reference herein and made a part of this specification.

### BACKGROUND

1. Field of the Invention

The invention is directed to a data accessing method and more particularly, to a database system and a data accessing method thereof.

2. Description of Related Art

In recent years, with the rapid spread of the Internet and improvements in software and hardware technology, users' demands for information services have become increasingly high, such that streaming technologies for databases have grown and developed quickly. A database represents data storage capacity in a large-scale, which is capable of accessing data from a remote end via the network in a circumstance that there is limited source in a local end. In other words, a user can request to access data from a server via a personal electronic apparatus, and the server can provide the data to the electronic apparatus in response to the request of the electronic apparatus. The electronic apparatus can proceed to a following procedure only when the required data is received, and therefore, the fluency of the electronic apparatus executing a program is influenced by a speed for accessing the data of the server.

### SUMMARY

Accordingly, the invention provides a database and a data accessing method thereof capable of accelerating data accessing speed.

The invention is directed to a database, including a memory, a central processing unit (CPU), a data storage element and a data cache element. The memory is configured to store a kernel program. The CPU is coupled to the memory and configured to execute the kernel program. The data storage element and the data cache element are coupled to the CPU. When receiving a data read command from an application, the kernel program determines whether the data storage element is set for accelerated data accessing. When the data storage element is set for the accelerated data accessing, the kernel program guides the data read command to read a copy file from the data cache element. The copy file is corresponding to a target file in the data storage element. When receiving a data write command from the application, the kernel program determines whether the data storage element is set for the accelerated data accessing. When the data storage element is set for the accelerated data accessing, the kernel program writes a file of the data write command into both the data storage element and the data cache element simultaneously.

In an embodiment of the invention, when the data storage element is set for the accelerated data accessing, and the copy file is not in the data cache element, the kernel program reads the target file and a first file path corresponding to the target file from the data storage element, modifies the first file path corresponding to the target file, stores the copy file in the data cache element and sets a second file path corresponding to the copy file to be the same as the first file path read by the kernel program.

In an embodiment of the invention, the kernel program establishes a file-mapping file under the second file path to record a location of at least one storage block of the copy file.

In an embodiment of the invention, when the data storage element is set for unaccelerated data accessing, the kernel program reads the target file according to the data read command.

In an embodiment of the invention, when the data storage element is set for the unaccelerated data accessing, the kernel program writes the file only into the data storage element.

In an embodiment of the invention, the kernel program is applied in a UNIX operating system (OS) or a UNIX-like OS.

In an embodiment of the invention, the kernel program includes a virtual file system (VFS) module and a filesystem in userspace (FUSE) module. The VFS module is configured to provide a data read request after receiving the data read command and provide a data write request after receiving the data write command. The FUSE module is configured to determine whether the data storage element is set for the accelerated data accessing when receiving the data read request. When the data storage element is set for the accelerated data accessing, and the copy file is not in the data cache element, the FUSE module reads the target file and a first file path corresponding to the target file from the data storage element, modifies the first file path corresponding to the target file, copies the target file as the copy file, stores the copy file in the data cache element and sets a second file path corresponding to the copy file to be the same as the first file path read by the FUSE module. When the data storage element is set for the accelerated data accessing, and the copy file is in the data cache element, the FUSE module reads the copy file. The FUSE module is configured to determine whether the data storage element is set for the accelerated data accessing when receiving the data write request. When the data storage element is set for the accelerated data accessing, the FUSE module writes the file into both the data storage element and the data cache element simultaneously according to the data write request.

In an embodiment of the invention, the data storage element is a hard disk (HD) storage device and the data cache element is a solid state disk (SSD) storage device.

The invention is directed to a data accessing method of a database, including the following steps. A kernel program stored in a memory is executed by a CPU. When a data read command is received by the kernel program from an application, whether a data storage element is set for accelerated data accessing is determined by the kernel program. When the data storage element is set for the accelerated data accessing, the data read command is guided to read a copy file from a data cache element by the kernel program. The copy file is corresponding to a target file in the data storage element. When a data write command is received by the kernel program from the application, whether the data storage element is set for the accelerated data accessing is determined by the kernel program. When the data storage element is set for the accelerated data accessing, a file of the data write command is written into both the data storage element and the data cache element simultaneously by the kernel program.

In an embodiment of the invention, the step of guiding the data read command to read the copy file from the data cache element by the kernel program includes the following step. When the data storage element is set for the accelerated data accessing, and the copy file is not in the data cache element, the target file and a first file path corresponding to the target file are read from the data storage element, the first file path corresponding to the target file is modified, the target file is copied as the copy file, the copy file is stored in the data cache element, and a second file path corresponding to the copy file is set to be the same as the first file path read by the kernel program by the kernel program.

In an embodiment of the invention, the data accessing method further includes establishing a file-mapping file under the second file path to record a location of at least one storage block of the copy file by the kernel program.

In an embodiment of the invention, the target file and the first file path read by the kernel program are stored in the memory.

In an embodiment of the invention, the data accessing method further includes when the data storage element is set for unaccelerated data accessing, reading the target file according to the data read command by the kernel program.

In an embodiment of the invention, the data accessing method further includes writing the file only into the data storage element by the kernel program when the data storage element is set for the unaccelerated data accessing.

In an embodiment of the invention, the file of the data write command received by the kernel program is stored in the memory.

To sum up, the data accessing method of the database provided by the embodiments of the invention contributes to determining whether the data storage element is set for the accelerated data accessing, so as to determine whether to accelerate data accessing speed by means of the data cache element.

In order to make the aforementioned and other features and advantages of the invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic system diagram of a database according to an embodiment of the invention.

FIG. 2 is a schematic diagram of data accessing according to an embodiment of the invention.

FIG. 3 is a flowchart of a data accessing method of a database according to an embodiment of the invention.

### DESCRIPTION OF EMBODIMENTS

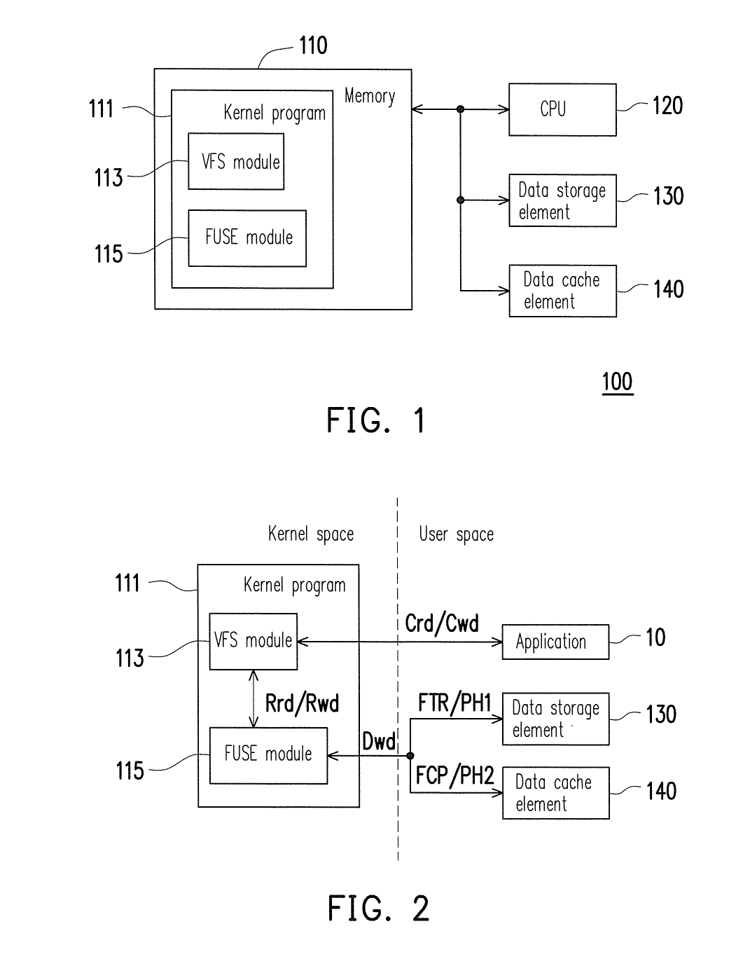

FIG. 1 is a schematic system diagram of a database according to an embodiment of the invention. Referring to FIG. 1, in the present embodiment, a database 100 includes a memory 110, a central processing unit (CPU) 120, a data storage element 130 and a data cache element 140, for example. The data storage element 130 may be a data storage element with a large capacity but a slow access speed, such as a hard disk (HD) storage device, and the data cache element 140 may be a data storage element with a small capacity but a fast access speed, such as a solid state disk (SSD) storage device, but the invention is not are not limited thereto.

The CPU 120 is coupled with the memory 110, the data storage element 130 and the data cache element 140. The CPU 120 may be coupled with the memory 110, the data storage element 130 and the data cache element 140 via different intermediate elements, such as a chipset, a bus, and so on, but the invention is not limited thereto. In the present embodiment, the memory 110 is configured to store a kernel program 111, and the CPU 120 coupled to the memory 110 is configured to execute the kernel program 111. In the meantime, the kernel program 111 is assumed to be applied in a UNIX or a UNIX-like operation system (OS). Namely, the kernel program 111 may include a virtual file system (VFS) module 113 and a filesystem in userspace (FUSE) module 115.

FIG. 2 is a schematic diagram of data accessing according to an embodiment of the invention. Referring to FIG. 1 and FIG. 2, FIG. 2 is used to illustrate flows of commands and data, instead of a real structure, where the same or similar reference numerals represent the same or similar elements in the following embodiments. In the present embodiment, application 10, the data storage element 130 and the data cache element 140 belong to a user space. Namely, a user can operate, use and set the application 10, the data storage element 130 and the data cache element 140. The kernel program 111 belongs to a kernel space. Namely, the user cannot set the kernel program 111 easily as desired.

When receiving a data read command Crd from the application 10, the kernel program 111 determines whether the data storage element 130 is set for accelerated data accessing. When the data storage element 130 is set for the accelerated data accessing, the kernel program 111 guides the data read command Crd to read a copy file FCP from the data cache element 140, where the copy file FCP is the same as a target file FTR to be read from the data storage element 130 by the data read command Crd. Due to the access speed of the data cache element 140 being faster than the access speed of the data storage element 130, a speed for accessing a file from the data cache element 140 is accelerated when the data storage element 130 is set for the accelerated data accessing. When the data storage element 130 is set for unaccelerated data accessing, the kernel program 111 directly reads the target file FTR from the data storage element 130 according to the data read command Crd to provide corresponding files to the application 10.

Furthermore, when the VFS module 113 of the kernel program 111 receives the data read command Crd from the application 10, the VFS module 113 provides a data read request Rrd to the FUSE module 115 of the kernel program 111 in response to the data read command Crd. When receiving the data read request Rrd, the FUSE module 115 determines whether the data storage element 130 is set for the accelerated data accessing.

When the data storage element 130 is set for the accelerated data accessing, and the corresponding copy file FCP is in the data cache element 140, the FUSE module 115 directly reads the copy file FCP from the data cache element 140 to provide the copy file FCP to the application 10. When the data storage element 130 is set for the accelerated data accessing, but the corresponding copy file FCP is not in the data cache element 140, the FUSE module 115 reads the target file FTR and a first file path PH1 corresponding to the target file FTR from the data storage element 130 and then modifies the first file path PH1 for storing the target file FTR.

Then, the FUSE module 115 copies the target file FTR as a copy file FCP, stores the copy file FCP in the data cache element 140 and sets a second file path PH2 corresponding to the copy file FCP to be the same as the first file path PH1 read by the FUSE module 115, i.e., changes the file path originally corresponding to the target file FTR as corresponding to the copy file FCP. The target file FTR and the first file path PH1 read by the FUSE module 115 may be stored in the memory 110.

When the data storage element 130 is set for the unaccelerated data accessing, the FUSE module 115 directly reads the target file FTR from the data storage element 130 according to the data read request Rrd to provide the file requested by the application 10.

In light of the foregoing, the database 100 of the present embodiment can be considered as a file-based data cache system and guide the data read command Crd to read the copy file FCP from the data cache element 140 by means of copying the file, modifying and setting the file path. Thus, the database 100 of the present embodiment does not incur burdens for data storing and data searching, which facilitates in saving usage of the memory 110 and accelerating the speed for file searching.

In the present embodiment, the FUSE module 115 establishes a file-mapping file under the second file path PH2 to record a location of at least one storage block of the copy file FCP. Namely, the file-mapping file serves to confirm whether file content of each data block in the data cache element 140 is used (i.e., valid), where each data block may be the smallest reading unit (e.g., 4 k bytes) of the FUSE module 11. Additionally, the file-mapping file may record the location of the at least one storage block of the copy file FCP with bits or bytes as the unit, i.e., record the location of the at least one storage block of the copy file FCP by means of bit mapping or pointer.

On the other hand, when receiving a data write command Cwd from the application 10, the kernel program 111 determines whether the data storage element 130 is set for accelerated data accessing. When the data storage element 130 is set for the accelerated data accessing, the kernel program 111 writes a file Dwd of the data write command Cwd into both the data storage element 130 and the data cache element 140 simultaneously. When the data storage element 130 is set for unaccelerated data accessing, the kernel program 111 writes the file Dwd only into the data storage element 130. The file Dwd of the data write command Cwd received by the kernel program 111 is stored in the memory 110.

Furthermore, when the VFS module 113 of the kernel program 111 receives the data write command Cwd from the application 10, the VFS module 113 provides a data write request Rwd to the FUSE module 115 of the kernel program 111 in response to the data write command Cwd. When the FUSE module 115 receives the data write request Rwd, the FUSE module 115 determines whether the data storage element 130 is set for the accelerated data accessing.

When the data storage element 130 is set for the accelerated data accessing, the FUSE module 115 writes the file Dwd into both the data storage element 130 and the data cache element 140 simultaneously according to the data write request Rwd. When the data storage element 130 is set for the unaccelerated data accessing, the FUSE module 115 writes the file Dwd only into the data storage element 130 according to the data write request Rwd.

Accordingly, in the present embodiment, the data cache function can be achieved by means of modifying the FUSE module 115, without re-coding the kernel program 111 for intercepting the command to be received by the VFS module 113 and thereby, contribute to less complexity of program modification.

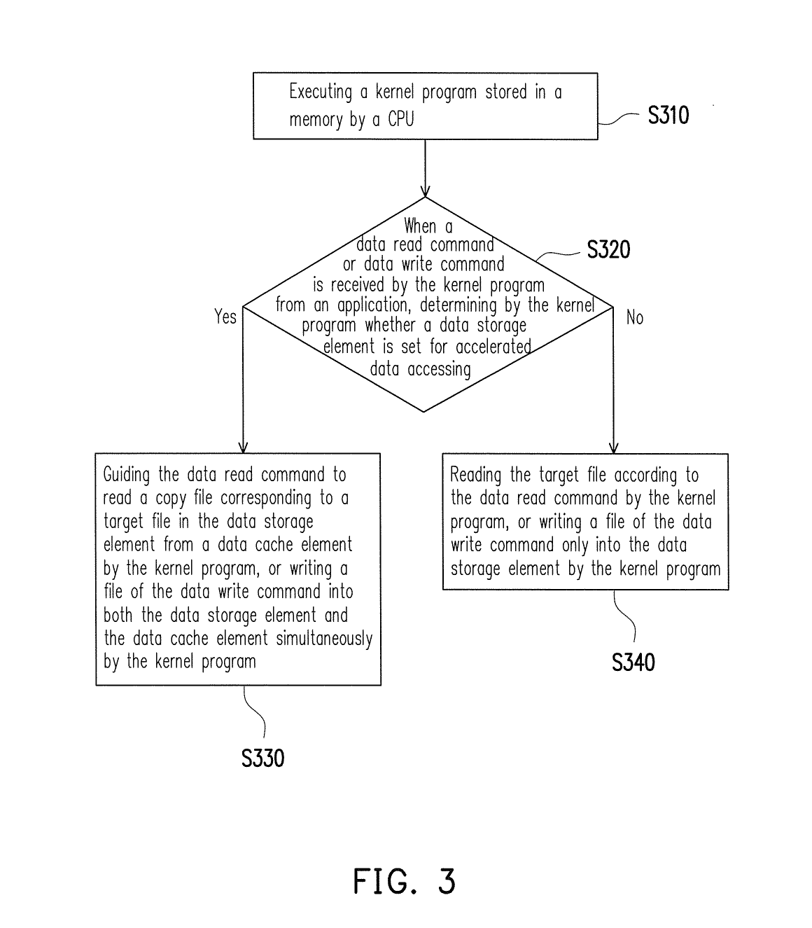

FIG. 3 is a flowchart of a data accessing method of a database according to an embodiment of the invention. Referring to FIG. 3, in the present embodiment, a data accessing method of a database includes the following steps. A kernel program stored in a memory is executed by a CPU (step S310). When a data read command or a data write command from an application is received by the kernel program, whether a data storage element is set for accelerated data accessing is determined by the kernel program (step S320). When the data storage element is set for the accelerated data accessing, i.e., the determination result of step S320 is “Yes”, the data read command is guided to read a copy file corresponding to a target file of the data storage element from a data cache element by the kernel program, or alternatively, a file of the data write command is written into both the data storage element and the data cache element simultaneously by the kernel program (step S330). When the data storage element is set for the unaccelerated data accessing, i.e., the determination result of step S320 is “No”, the target file is read according to the data read command by the kernel program, or alternatively, the file of the data write command is written only into the data storage element by the kernel program (step S340). The sequence of steps S310, S320, S330 and S340 are used for descriptions, and the invention is not limited thereto. Meanwhile, details with respect to steps S310, S320, S330 and S340 may refer to the descriptions related to the embodiments illustrated in FIG. 1 and FIG. 2 and thus, will not be repeated.

To summarize, the data accessing method of the database provided by the embodiments of the invention contributes to determining whether the data storage element is set for the accelerated data accessing, so as to determine whether to accelerate data accessing speed by means of the data cache element.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A database, comprising:
a memory, configured to store a kernel program;
a CPU, coupled to the memory and configured to execute the kernel program;
a data storage element, coupled to the CPU; and
a data cache element, coupled to the CPU,
wherein when receiving a data read command from an application, the kernel program determines whether the data storage element is set for accelerated data accessing, and when the data storage element is set for the accelerated data accessing, the kernel program guides the data read command to read a copy file from the data cache element, wherein the copy file is corresponding to a target file in the data storage element, and
when receiving a data write command from the application, the kernel program determines whether the data storage element is set for the accelerated data accessing, and when the data storage element is set for the accelerated data accessing, the kernel program writes a file of the data write command into the data storage element and the data cache element simultaneously.

2. The database according to claim 1, wherein when the data storage element is set for the accelerated data accessing and the copy file is not in the data cache element, the kernel program reads the target file of the data storage element and a first file path corresponding to the target file, modifies the first file path corresponding to the target file, copies the target file as the copy file, stores the copy file in the data cache element, and sets a second file path corresponding to the copy file to be the same as the first file path read by the kernel program.

3. The database according to claim 2, wherein the kernel program establishes a file-mapping file under the second file path to record a location of at least one storage block of the copy file.

4. The database according to claim 2, wherein the target file and the first file path read by the kernel program are stored in the memory.

5. The database according to claim 1, wherein when the data storage element is set for unaccelerated data accessing, the kernel program reads the target file according to the data read command.

6. The database according to claim 1, wherein when the data storage element is set for unaccelerated data accessing, the kernel program writes the file only into the data storage element.

7. The database according to claim 1, wherein the file of the data write command received by the kernel program is stored in the memory.

8. The database according to claim 1, wherein the kernel program is applied in a UNIX operating system (OS) or a UNIX-like OS.

9. The database according to claim 8, wherein the kernel program comprises:
a virtual file system (VFS) module, configured to provide a data read request after receiving the data read command and provide a data write request after receiving the data write command; and
a filesystem in userspace (FUSE) module, configured to determine whether the data storage element is set for the accelerated data accessing when receiving the data read request, and determine whether the data storage element is set for the accelerated data accessing when receiving the data write request,
wherein when the data storage element is set for the accelerated data accessing, and the copy file is not in the data cache element, the FUSE module reads the target file and a first file path corresponding to the target file from the data storage element, modifies the first file path corresponding to the target file, copies the target file as the copy file, stores the copy file in the data cache element and sets a second file path corresponding to the copy file to be the same as the first file path read by the FUSE module, and
when the data storage element is set for the accelerated data accessing, and the copy file is in the data cache element, the FUSE module reads the copy file, and
when the data storage element is set for the accelerated data accessing, the FUSE module writes the file into both the data storage element and the data cache element simultaneously according to the data write request.

10. The database according to claim 1, wherein the data storage element is a hard disk (HD) storage device and the data cache element is a solid state disk (SSD) storage device.

11. A data accessing method for a database, comprising:
executing a kernel program stored in a memory by a CPU;
when a data read command is received by the kernel program from an application, determining by the kernel program whether a data storage element is set for accelerated data accessing;
when the data storage element is set for the accelerated data accessing, guiding the data read command to read a copy file from a data cache element by the kernel program, wherein the copy file is corresponding to a target file in the data storage element;
when a data write command is received by the kernel program from the application, determining by the kernel program whether the data storage element is set for the accelerated data accessing; and
when the data storage element is set for the accelerated data accessing, writing a file of the data write command into both the data storage element and the data cache element simultaneously by the kernel program.

12. The method according to claim 11, wherein the step of guiding the data read command to read the copy file from the data cache element by the kernel program comprises:
when the data storage element is set for the accelerated data accessing, and the copy file is not in the data cache element, reading the target file and a first file path corresponding to the target file from the data storage element, modifying the first file path corresponding to the target file, copying the target file as the copy file, storing the copy file in the data cache element and setting a second file path corresponding to the copy file to be the same as the first file path read by the kernel program by the kernel program.

13. The method according to claim 12, further comprising:
establishing a file-mapping file under the second file path to record a location of at least one storage block of the copy file by the kernel program.

14. The method according to claim 12, wherein the target file and the first file path read by the kernel program are stored in the memory.

15. The method according to claim 11, further comprising:
when the data storage element is set for unaccelerated data accessing, reading the target file according to the data read command by the kernel program.

16. The method according to claim 11, further comprising:
when the data storage element is set for unaccelerated data accessing, writing the file only into the data storage element by the kernel program.

17. The method according to claim 16, wherein the file of the data write command received by the kernel program is stored in the memory.
